(19) United States
(12) Patent Application Publication
(10) Pub. No.: US 2008/0050712 A1
(43) Pub. Date: Feb. 28, 2008

(54) Concept learning system and method

(75) Inventors: Omid Madani, San Gabriel, CA (US); Wiley Greiner, Santa Monica, CA (US)

Correspondence Address: THELEN REID BROWN RAYSMAN & STEINER LLP, PO BOX 1510, NEW YORK, NY, 10150-1510, US

(73) Assignee: Yahoo! Inc., Sunnyvale, CA (US)

(21) Appl. No.: 11/502,949

(22) Filed: Aug. 11, 2006

(51) Int. Cl. G09B 3/00

(52) U.S. Cl. 434/350

(57) ABSTRACT

According to a preferred embodiment, a concept learning system and method is used for classifying instances, which, for example, may include web pages or text documents. An instance is input into the system. One or more candidate concepts are recalled from a set of candidate concepts. For each recalled concept, a classifier that corresponds to it is applied to the instance to determine if the recalled concept is related to the instance. Samples are selected from a training set. A learning method is applied, and a set of candidate concepts are updated according to the results from applying the learning method.

### FIELD OF THE INVENTION

The invention is a concept learning system and method. Specifically, with the presentation of an instance, the system and method retrieves relevant and applicable concepts (categories) efficiently, and is especially useful for applications when the number of concepts is very large.

### BACKGROUND OF THE INVENTION

A biological organism, situated in a rich complex world, retains large numbers of concepts (or categories) in order to live intelligently. Humans, and even rodents, primates, and other sophisticated animals, are able to quickly identify specific concepts from a wide variety of candidate concepts (e.g., object types, concepts described by phrases in sentences, languages, visual concepts, and the like). Similar concepts share many features and may have complex representations (e.g., linear threshold functions). In order to duplicate such a process using a computer, for example, for the task of identifying concepts to which a web page relates, a brute force examination, such as application of each of tens of thousands of classifiers, is not practically feasible.

Many tasks can be formulated as problems that require learning and recognizing numerous categories. In a number of existing text categorization tasks, such as categorizing web pages into the Yahoo! or Open Directory Project topic hierarchies, the number of categories range in the hundreds of thousands. For the task of prediction in text (or language) modeling, each possible word or phrase to be predicted can be viewed as its own category. Thus the number of categories can easily exceed hundreds of thousands. Similarly, visual categories useful for scene interpretation and image tagging are also numerous. In many of these domains, the number of instances is large or can be practically unbounded (such as in language modeling). Techniques that can scale to myriad categories have the potential to significantly impact such large scale learning tasks.

Research in cognitive science and psychology has stressed the importance of concepts and has focused on questions such as the nature of concepts as well as how they might be represented and acquired. The three major representation theories are classical theory (logical representations), exemplar theory (akin to nearest neighbours), and prototype theory (akin to linear representations). Mechanisms for managing concepts and rendering them operational remain largely un-researched.

In discriminative learning of binary classifiers, a classifier needs to be trained on negative as well positive instances. Training on all (negative) instances may not be feasible in the presence of large numbers of instances (possibly unbounded), and large numbers of concepts. Related research in this area includes psychology of concepts, fast recognition methods, existing candidate learning methods, online learning, online computations, self-adjusting data structures, streaming algorithms, speed up learning, blackboard systems, association lists, associative memory, and aspects or models of the brain and mind.

Concepts can serve as features and features as concepts. For fast classification, finding the relevant concepts can be approached as a problem of search for nearest points, where similarity is computed with respect to an instance at classification time. Perhaps this approach is most directly applicable in the setting where the classifiers are themselves instances (i.e., nearest neighbour classification methods). There are a number of data structure and algorithms for fast search, including trees such as kd-trees and metric trees, locality preserving hashing algorithms, and inverted indices. However, tree based algorithms do not achieve significant speed up in very high dimensional spaces. Locality preserving hashing methods may work sufficiently well for approximate search, but another potential drawback of nearest neighbour methods is that they do not generalize as well as linear methods.

Candidate methods for learning efficiently under numerous concepts include multi-class naive bayes, nearest neighbours, and learning generative models. The nearest neighbour method does not require training, naive bayes requires just one pass over data (or just a few for feature selection), and generative approaches may require only the positive instances for each concept. However, efficient classification remains a major issue with all these methods. The performance of naive bayes and nearest neighbour methods are often significantly inferior to the performance of appropriately trained linear classifiers in the presence of large numbers of irrelevant or correlated features. To become somewhat competitive, naive bayes requires ad-hoc feature selection and nearest neighbours requires similarity adaptation. The drawback of inferior performance also holds for generative models, unless fairly accurate generative models exist for the domain.

Accordingly, those skilled in the art have long recognized the need for a system and method to allow for classifying items into multiple categories per instance. This invention clearly addresses this and other needs.

### BRIEF SUMMARY OF THE INVENTION

According to a preferred embodiment, a concept learning system and method is used for classifying instances, which, for example, may include web pages, text documents, phrases, or images. An instance, represented by a vector of feature values, is input into the system. A set of candidate concepts is recalled from a large set of possible concepts. In one embodiment, the concepts are ranked and shown. In another embodiment, for each recalled concept, a classifier that corresponds to it is applied to the instance to determine if the recalled concept is related to the instance. Learning methods are used to learn such functionality.

In one preferred embodiment, the recall portion is realized by an index mapping features to concepts. A learning algorithm is used to learn the mapping. In one embodiment, the learning algorithm comprises a mistake driven algorithm, referred to as an indexer algorithm. In another preferred embodiment, the learning algorithm updates the index mapping features to concepts according to whether a false negative concept or a false positive concept is retrieved by use of the index.

In yet another preferred embodiment, the set of classifiers are learned when the index is learned.

In yet another preferred embodiment, a computer program product is stored on a computer-readable medium having instructions for performing the steps of: inputting an instance; recalling one or more candidate concepts from a set of candidate concepts; for each recalled concept, applying a classifier for each recalled concept to determine if the recalled concept is related to the instance; for each recalled concept, selecting samples from a sample training set; applying a learning algorithm using the selected samples; and updating the set of candidate concepts according to the results from applying the learning algorithm.

### BRIEF DESCRIPTION OF THE DRAWINGS

FIG. 1 is a block diagram illustrating components of a search engine in which one embodiment operates;

FIG. 2 is an example of a news web page that can be categorized using one embodiment;

FIG. 3 is a flow diagram illustrating steps performed in a recall method performed by a system according to one embodiment;

FIG. 4 is a bipartite graph illustrating an exemplary structure of the index according to one embodiment; and

FIG. 5 is a flow diagram illustrating the steps performed by the system in a max norm indexer learning method according to one embodiment.

### DETAILED DESCRIPTION OF THE PREFERRED EMBODIMENTS

A preferred embodiment of a system and method for learning and recognizing concepts efficiently in the presence of large numbers of concepts uses a recall system designed for efficient high recall rates. Given an instance, the system quickly determines the relevant concepts from myriad concepts that are known to the system. In one embodiment, the recall system uses an inverted index that is learned in an online mistake driven fashion.

The inverted index is used as a data structure for efficient retrieval of documents or other objects. The learning approach in one embodiment makes its construction and use more dynamic. In one embodiment, the classifiers are embodied as short programs or procedures. Thus, the system and method extends the use of the inverted index to efficient retrieval of appropriate programs or procedures.

Learning to classify into a hierarchy by conditionally training of (binary) classifiers for each node is an effective method. However, the recall system described herein allows ultimately for significantly more flexibility. In many applications of the system, a prediction problem is best served (both in efficiency as well as accuracy) by an embodiment of the recall system supporting multiple layers, even if it is thought that the categories form a rigid hierarchy. “Flat” training of binary classifiers is used in this embodiment, although additional layers of the recall system can be used.

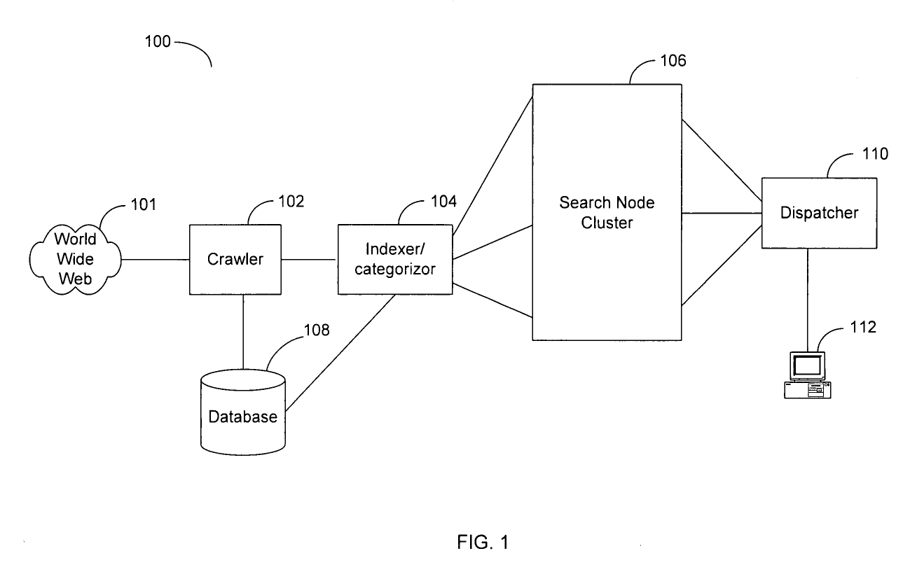

In one embodiment, as an example, and not by way of limitation, an improvement in Internet search engine labeling of web pages is provided. The World Wide Web is a distributed database comprising billions of data records accessible through the Internet. Search engines are commonly used to search the information available on computer networks, such as the World Wide Web, to enable users to locate data records of interest. A search engine system 100 is shown in FIG. 1. Web pages, hypertext documents, and other data records from a source 101, accessible via the Internet or other network, are collected by a crawler 102. The crawler 102 collects data records from the source 101. For example, in one embodiment, the crawler 102 follows hyperlinks in a collected hypertext document to collect other data records. The data records retrieved by crawler 102 are stored in a database 108. Thereafter, these data records are indexed by an indexer 104. Indexer 104 builds a searchable index of the documents in database 108. Common prior art methods for indexing may include inverted files, vector spaces, suffix structures, and hybrids thereof. For example, each web page may be broken down into words and respective locations of each word on the page. The pages are then indexed by the words and their respective locations. A primary index of the whole database 108 is then broken down into a plurality of sub-indices and each sub-index is sent to a search node in a search node cluster 106.

To use search engine 100, a user 112 typically enters one or more search terms or keywords, which are sent to a dispatcher 110. Dispatcher 110 compiles a list of search nodes in cluster 106 to execute the query and forwards the query to those selected search nodes. The search nodes in search node cluster 106 search respective parts of the primary index produced by indexer 104 and return sorted search results along with a document identifier and a score to dispatcher 110. Dispatcher 110 merges the received results to produce a final result set displayed to user 112 sorted by relevance scores.

As a part of the indexing process, or for other reasons, most search engine companies have a frequent need to categorize web pages as belonging to one “group” or another. For example, a search engine company may find it useful to determine if a web page is of a commercial nature (selling products or services), or not. As another example, it may be helpful to determine if a web page contains a news article about finance or another subject, or whether a web page is spam related or not. Such web page classification problems are binary classification problems (x versus not x). Classification usually involves processing unwanted features that can severely slow classification, making such classification unsuited to real-time application.

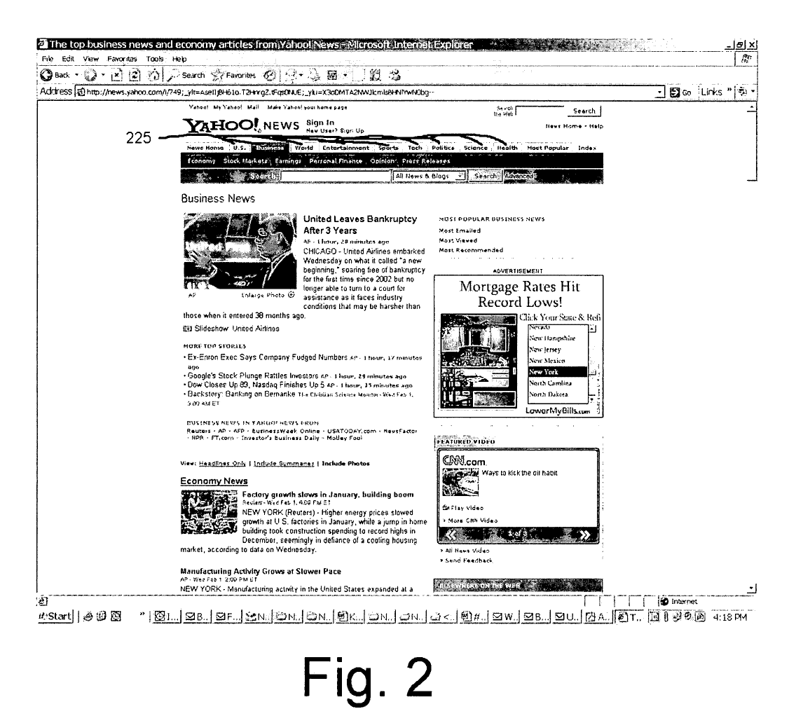

Referring to FIG. 2, there is shown an example of a web page that has been classified, or categorized. In this example, the web page is categorized as a “Business” related web page, as indicated by the topic indicator 225 at the top of the page. Other category indicators 225 are shown. Thus, if a user had searched for business categorized web pages, then the web page of FIG. 2 would be listed, having been classified or categorized as such.

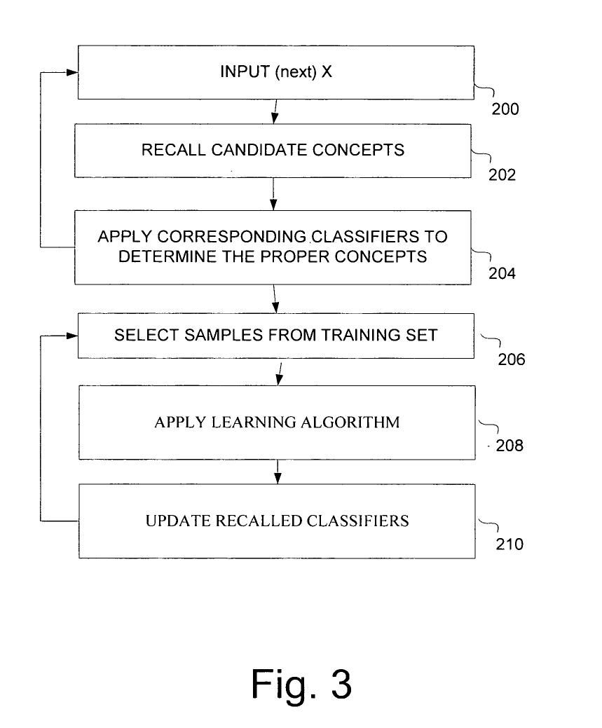

With reference to FIG. 3, a flow diagram illustrating steps performed in a recall method performed by system according to one embodiment is shown. According to one embodiment, in a categorization process, when an instance, such as a web page to be categorized is input, step 200, or presented, to the system, all concepts that are relevant are retrieved, step 202. In a classification task performed by the system, relevance means that concepts that are positive for the instance are found, which may encompass all concepts that the instance belongs to (for example, a web page is related to sports, and hockey). Further processing is performed subsequently, which is a function of the retrieved concepts and the instance. In this respect, in step 202, (binary) classifiers corresponding to the found concepts are applied to the instance to determine the categories of the instance, step 204. Other embodiments use multiple subsequent accesses to the recall system, as needed. Processing moves back to step 200 for the next instance to categorize.

During training, the recall system is trained so that, on average for each instance, relevant concepts are retrieved efficiently, and not too many positive concepts are missed. Optionally, in one embodiment, the binary classifiers corresponding to the retrieved concepts are trained within the system. The recall system imposes a distribution on the instances presented to the learning algorithms for each concept. Linear threshold classifiers, in particular perception and winnow algorithms with mistake driven updates can be used. Other learning algorithms can be used, as long as they do not necessarily require seeing all instances for training in order to perform adequately.

In one embodiment, the recall system is realized by an inverted index that maps each feature to a set of (zero or more) concepts. If C(f) is the set of concepts to which feature f maps, and f(x) denotes the set of features active (positive weight) in instance x, then the recall system retrieves the set of concepts ∪_{f}_{ᵢ}_{εf(x)}C(fᵢ), on input x. Efficiency (during system execution) implies that not only the retrieved set of concepts per instance should be manageable, (i.e., not too many irrelevant concepts be retrieved), but also computing such a set should be efficient.

In one embodiment, the index, i.e., the mappings C(fᵢ)∀ᵢ, is learned. During learning, each concept c is represented by a sparse vector of feature weights, ν_{c} (absent features have 0 weight). A concept is indexed by those features whose weight in the concept vector exceed a positive threshold τ:cεC(fᵢ)iffν_{c}[i]>τ. Thus the recall system implements effectively a disjunction for each concept, meaning that if a concept c is indexed by feature fᵢ and fᵢ for example, then c is retrieved when an instance has at least one of fᵢ or fᵢ.

Next, in a process for training the system that is on line, and performed by using one instance at a time, in step 206, for each instance, samples of labelled elements are selected from a training set (such as manually classified samples), and a learning algorithm is applied, 208. The set of recall classifiers is updated according to results from application of the learning algorithm, step 210. Processing moves back to step 206 for the next instance.

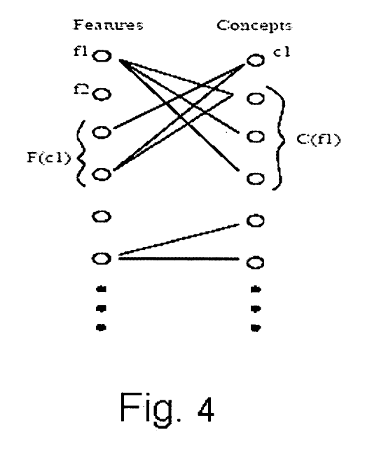

FIG. 4 illustrates an exemplary structure of the index as a bipartite graph. The cover (the edge set) is learned. Not all features necessarily index (map to) a concept. However, if the max norm indexer algorithm is used (such as that described below with respect to FIG. 3 below), any concept that has been seen before is preferably indexed by at least one feature. It is instructive to view an index as a bipartite graph of features versus concepts, in which there is an edge connecting a feature and a concept if f maps to c in the index. For a concept c, by its covering, F(c), means the set of features that index the concept, or F(c)={f|cεC(f)}. F(c) and C(F) are symmetric notions, each being the set of neighbours of a vertex on the other side. The whole bipartite graph is simply a covering or an index. Thus a covering determines for each concept c a set of features that index it.

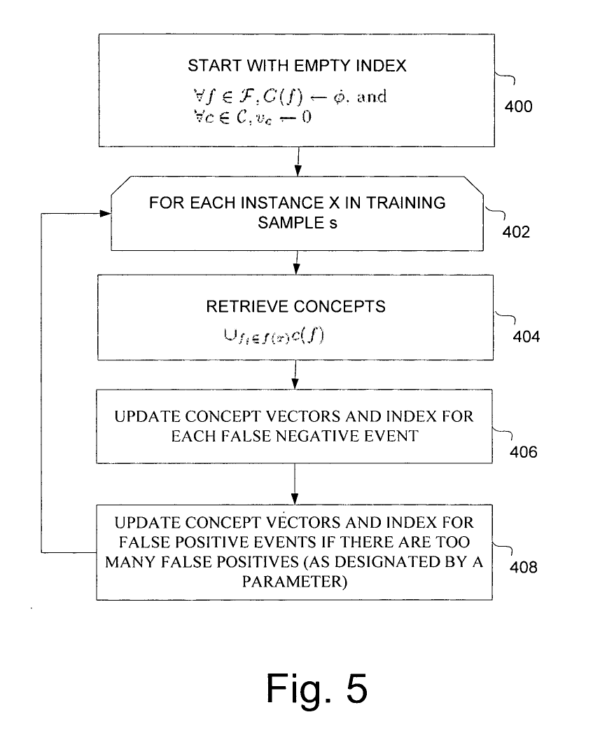

With reference to FIG. 5, the steps performed by the system in a max norm indexer learning method are illustrated. In this embodiment, the indexer method is online (computerized) and mistake driven. In this embodiment, a concept is a false negative if it is a positive concept (for the given instance), but is not retrieved. A false positive is a retrieved concept that is not positive (for the instance). The method begins with the 0 vector for each concept and an empty index, step 400. For each instance x in the training sample set S, step 402, the concepts are retrieved, step 404. The concept vectors and the index are updated for every false negative event, step 406. The method “promotes” the weights of the features of the instance in the vector of every false negative concept. Update also occurs whenever the number of false positive concepts exceed a threshold τ,τ≧0, which is referred to as demoting the weights of the features, step 408. Processing then moves back to step 402 for the next instance. 100321 The following pseudo code reiterates the above discussed method. A subroutine called Adjust is used to perform the updating of the index the category vectors.

Algorithm MaxNorm(τ, pf, df)

Begin with empty index:

$\begin{matrix}∀ f ∈ ℱ , C ( f ) ← φ , and \\ ∀ c ∈ 𝒞 , {v}_{c} ← 0\end{matrix}$

For each instance x in training sample S:

$retrieve concepts \text{:} {⋃}_{{f}_{i} ∈ f ( x )} c ( f )$
promote for each false negative concept c:

Adjust(x, c, promotion factor)

if fp count is greater that tolerance τ,
demote for each false positive concept c:

Adjust(x, c, demotion-factor)

Subroutine Adjust(instance x, concept c, factor r)

for every feature fᵢ ∈ f(x)

v_{c}[i] ← v_{c}[i] * r

$max normalize {v}_{c} : ∀ {f}_{t} {v}_{c} [ i ] ← \frac{{v}_{c} [ i ]}{{max}_{j} {v}_{c} [ j ]}$
update index for c so the following conditions holds:

c ∈ C(fₜ) iff v_{c}[i] > τ

In one embodiment, the max normalization step in the Adjust subroutine is dropped for some objectives in which a significant difference in the average false negative rate (average number of categories missed per test instance) is not present if that subroutine is dropped. Promotion and demotion factors of 2 and 0.5 have worked adequately. During promotion, when a feature is first added to a category vector, its weight can be initialized to 1.0 or 1/df, before being multiplied by r, where df is its frequency count seen so far in the instances. 1/df has been observed to work better.

The recall system improves in performance over time. Performance includes both efficiency measures such as speed and memory requirements of the recall system, as well as accuracy measures, including recall rates as well as false positive counts.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A concept learning method, comprising:
inputting an instance;
recalling one or more candidate concepts from a set of candidate concepts;
for each recalled concept, applying a to determine if the recalled concept is related to the instance;
for each recalled concept, selecting samples from a sample training set;
applying a learning algorithm using the selected samples; and
updating the set of candidate concepts according to the results from applying the learning algorithm.

2. The method of claim 1, further comprising updating an index for the set of candidate concepts.

3. The method of claim 2, wherein the learning algorithm is on-line and mistake driven.

4. The method of claim 3, wherein the learning algorithm updates vectors for a false negative concept, and updates vectors for a false positive concept if a number of false positive concepts meets a threshold.

5. The method of claim 4, further comprising updating an index of the vectors.

6. A system for concept learning, comprising:
in input device for inputting an instance;
a processor for recalling one or more candidate concepts from a set of candidate concepts;
for each recalled concept, the processor further for applying a classifier for each recalled concept to determine if the recalled concept is related to the instance;
for each recalled concept, the processor further for selecting samples from a sample training set;
the processor further for applying a learning algorithm using the selected samples; and
the processor further for updating the set of candidate concepts according to the results from applying the learning algorithm.

7. The system of claim 6, wherein the processor further updates an index for the set of candidate concepts.

8. The system of claim 7, wherein the learning algorithm is on-line and mistake driven.

9. The system of claim 8, wherein the learning algorithm updates vectors for a false negative concept, and updates vectors for a false positive concept if a number of false positive concepts meets a threshold.

10. The system of claim 9, wherein the processor further updates an index of the vectors.

11. A computer program product stored on a computer-readable medium having instructions for performing the steps of:
inputting an instance;
recalling one or more candidate concepts from a set of candidate concepts;
for each recalled concept, applying a classifier for each recalled concept to determine if the recalled concept is related to the instance;
for each recalled concept, selecting samples from a sample training set;
applying a learning algorithm using the selected samples; and
updating the set of candidate concepts according to the results from applying the learning algorithm.
